(19) United States
(12) Patent Application Publication
(10) Pub. No.: US 2014/0070523 A1
(43) Pub. Date: Mar. 13, 2014

(54) MULTILAYER AUTOMOBILE SPLASHBOARD STRUCTURE

(71) Applicant: Fu-Man SHIH, New Taipei City (TW)

(72) Inventor: Fu-Man SHIH, New Taipei City (TW)

(21) Appl. No.: 13/752,920

(22) Filed: Jan. 29, 2013

(30) Foreign Application Priority Data
Sep. 7, 2012 (TW) 101217352

(51) Int. Cl. B62D 25/16

(52) U.S. Cl. CPC B62D 25/16
USPC 280/851

(57) ABSTRACT

A multilayer automobile splashboard structure comprises a splashboard and a water guiding plate. The splashboard is connected to an automobile body above a tire. An arc shaped outer surface of the splashboard is corresponded to the tire, and a plurality of protruding portions is disposed on the outer surface. The water guiding plate is provided on the outer surface of the splashboard correspondingly and a water guiding space is formed between the water guiding plate and the outer surface. A plurality of holes is disposed on the water guiding plate corresponding to the protruding portions on the outer surface respectively. Thereby, the water flinged off from the tire can be splashed into the holes and dashed on the protruding portions. Then, the water is discharged from two sides of the each of the protruding portions along the water guiding space.

### BACKGROUND OF THE INVENTION

1. Field of Invention

The present invention relates to a multilayer automobile splashboard structure with a simple design which can effectively prevent water mist from producing from rotating tires of vehicles driven in high speed in rainy conditions.

2. Related Art

Splashboard is usually installed on vehicle body above tires for preventing rain or dirty water from splashing on the vehicle body in motion. For large vehicles such as truck, passenger vehicle and combination vehicle, water splashing from the tires is even more severe in high speed in rainy conditions. Water is thrown backward in high speed after being splashed from the roads by the tires. The water dashing on the splashboard will be spread to become water mist or tiny water droplets.

Furthermore, water mist produced from vehicles driven in high speed in rainy conditions will be stirred and spread by the ascending air current at the vehicle backs to become a wall of water mist wider than the vehicle body. The water mist wall will block the view of drivers behind and affect the road safety of vehicles behind. This is why the percentage of car accidents in rainy conditions is higher.

### SUMMARY OF THE INVENTION

The main object of the present invention is to provide a multilayer automobile splashboard structure with a simple design which can effectively prevent water mist from producing from rotating tires of vehicles driven in high speed in rainy conditions.

In order to achieve the above-mentioned object, present invention provides a multilayer automobile splashboard structure comprising a splashboard and a water guiding plate. The splashboard is connected to an automobile body above a tire. The splashboard having an outer surface disposed corresponding to the tire, and a plurality of protruding portions is disposed on the outer surface. The water guiding plate is provided on the outer surface of the splashboard correspondingly and a water guiding space is formed between the water guiding plate and the outer surface. A plurality of holes is disposed on the water guiding plate corresponding to the protruding portions on the outer surface respectively. Thereby, the water flinged off from the tire can be splashed into the holes and dashed on the protruding portions. Then, the water is discharged from two sides of the each of the protruding portions along the water guiding space.

In implementation, each of the protruding portions is an arc shaped, a tapering or a polygonal protruding portion.

In implementation, a guiding plate is disposed at each of the holes of the water guiding plate. The guiding plate is disposed facing the protruding portion and the guiding plate is bent at an angle corresponding to the hole.

In implementation, the outer surface of the splashboard corresponding to the tire is in an arc shape.

The present invention will become more fully understood by reference to the following detailed description thereof when read in conjunction with the attached drawings.

### BRIEF DESCRIPTION OF THE DRAWINGS

FIG. 1 is an illustration of a multilayer automobile splashboard structure according to the invention;

FIG. 2 is a perspective exploded view of the multilayer automobile splashboard structure according to the present invention;

FIG. 3 is an illustration showing the combination of a splashboard and a water guiding plate according to the present invention;

FIG. 3A is a partially enlarged view of the part “a” in FIG. 3; and

FIGS. 4 to 7 are enlarged illustrations of a protruding portion and a hole in various shapes according to the present invention.

### DETAILED DESCRIPTION OF THE INVENTION

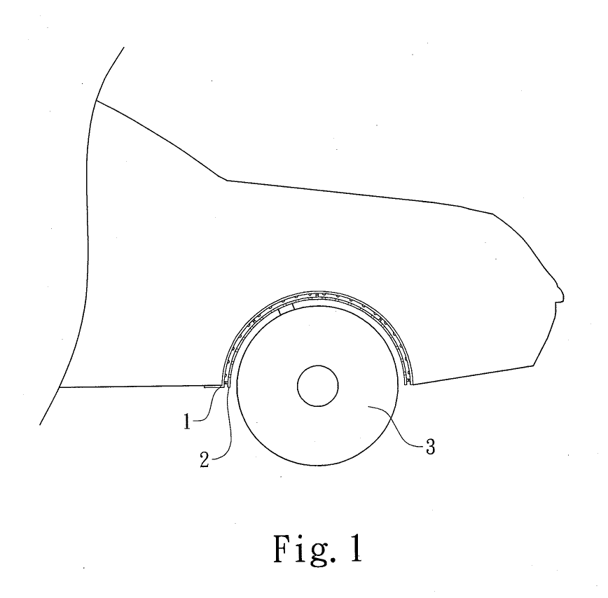

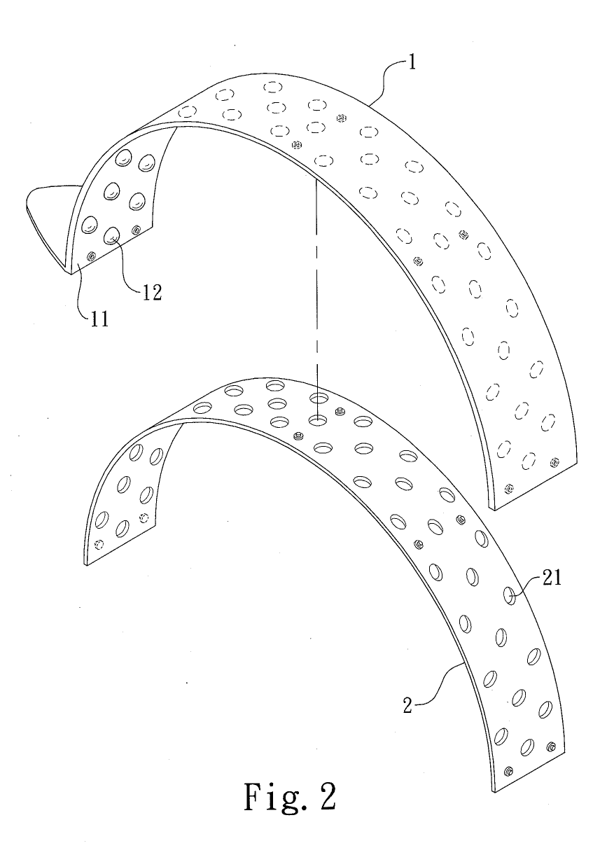

Please refer to FIGS. 1 to 3A. FIGS. 1 to 3A are illustrations of a multilayer automobile splashboard structure according to an embodiment of the disclosure. The multilayer automobile splashboard structure is composed of a splashboard 1 and a water guiding plate 2.

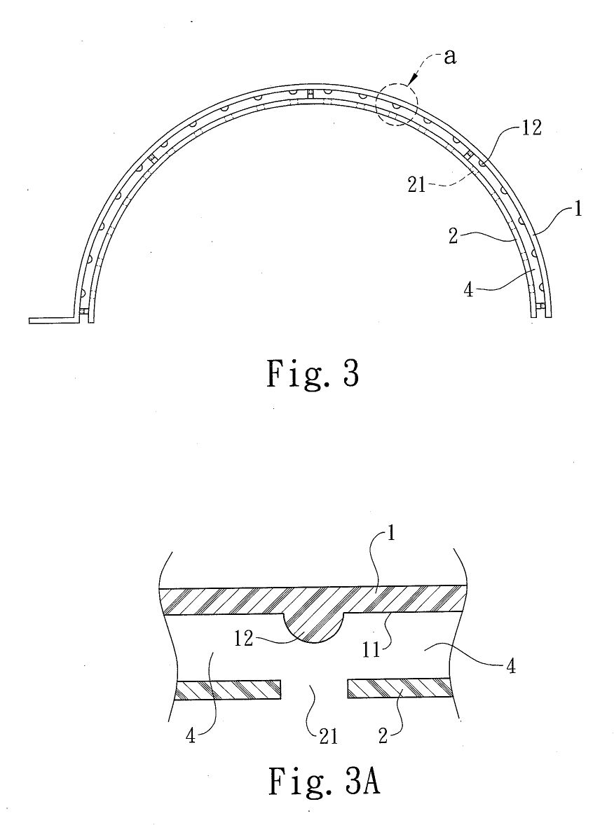

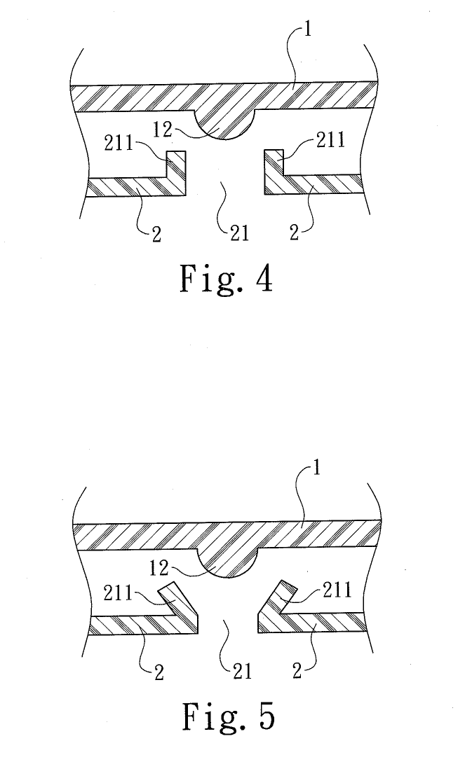

The splashboard 1 is connected to an automobile body above a tire 3. An arc shaped outer surface 11 of the splashboard 1 is corresponded to the tire 3, and a plurality of protruding portions 12 is disposed on the outer surface 11. Each of the protruding portions 12 is in an arc shape, a tapering shape or a polygonal shape as shown in FIGS. 3A, 6 and 7.

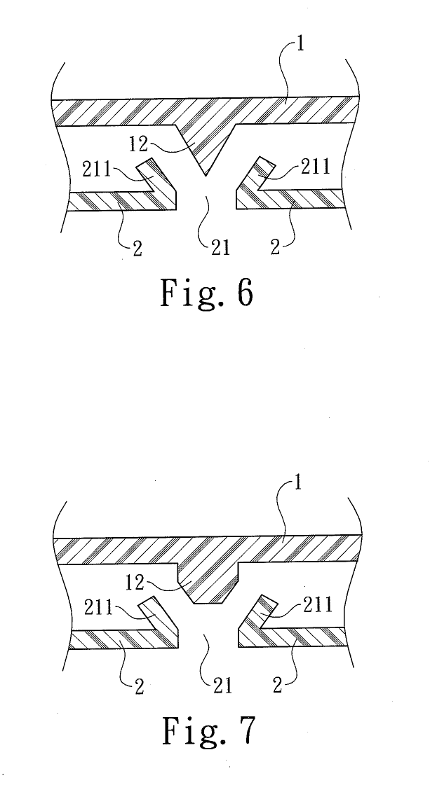

The water guiding plate 2 is provided on the outer surface 11 of the splashboard 1 correspondingly and a water guiding space 4 is foamed between the water guiding plate 2 and the outer surface 11. A plurality of holes 21 is disposed on the water guiding plate 2 corresponding to the protruding portions 12 on the outer surface 11 respectively. A guiding plate 211 is disposed at each of the holes 21 of the water guiding plate 2. The guiding plate 211 is disposed facing the protruding portion 12 and the guiding plate 211 is bent at an angle corresponding to the hole 21 as shown in FIGS. 4 and 5.

Thereby, when vehicles are driven in high speed in rainy conditions, the water flinged off from the tire 3 can be splashed into the holes 21 and dashed on the arc shaped, tapering shaped or polygonal shaped protruding portions 12. Then, the water is discharged from two sides of the each of the protruding portions 12 along the water guiding space 4.

Therefore, the present invention has the following advantages:

1. By using the water guiding space formed between the splashboard and the water guiding plate as well as the design of the protruding portions, the splashed water or dirty water entered from the holes of the water guiding plate can be blocked by the protruding portions, and then discharged by flowing to the water guiding space from the two sides of each of the protruding portions. Thereby, the water can be collected effectively for discharging, the produced water mist can be reduced substantially, and the occurrence of car accidents in rainy conditions can be reduced.

2. By using the guiding plates of the holes of the water guiding plate, besides that water can be effectively guided to flow to the water guiding space from the two sides of each of the protruding portions for discharging, the water in the water guiding space can be prevented from flowing reversely to flow outside the holes effectively.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A multilayer automobile splashboard structure, comprising:
a splashboard connected to an automobile body above a tire, wherein the splashboard has an outer surface disposed corresponding to the tire, and a plurality of protruding portions is disposed on the outer surface; and
a water guiding plate provided on the outer surface of the splashboard correspondingly and a water guiding space being formed between the water guiding plate and the outer surface, a plurality of holes being disposed on the water guiding plate corresponding to the protruding portions on the outer surface respectively, thereby, water flinged off from the tire being splashed into the holes and dashed on the protruding portions, and then the water being discharged from two sides of the each of the protruding portions along the water guiding space.

2. The multilayer automobile splashboard structure as claimed in claim 1, wherein each protruding portion is an arc shaped protruding portion.

3. The multilayer automobile splashboard structure as claimed in claim 2, wherein a guiding plate is disposed at the hole of the water guiding plate, and the guiding plate is disposed facing the protruding portion.

4. The multilayer automobile splashboard structure as claimed in claim 3, wherein the guiding plate is bent at an angle corresponding to the hole.

5. The multilayer automobile splashboard structure as claimed in claim 1, wherein each protruding portion is a tapering protruding portion.

6. The multilayer automobile splashboard structure as claimed in claim 5, wherein a guiding plate is disposed at the hole of the water guiding plate, and the guiding plate is disposed facing the protruding portion.

7. The multilayer automobile splashboard structure as claimed in claim 6, wherein the guiding plate is bent at an angle corresponding to the hole.

8. The multilayer automobile splashboard structure as claimed in claim 1, wherein each protruding portion is a polygonal protruding portion.

9. The multilayer automobile splashboard structure as claimed in claim 8, wherein a guiding plate is disposed at the hole of the water guiding plate, and the guiding plate is disposed facing the protruding portion.

10. The multilayer automobile splashboard structure as claimed in claim 9, wherein the guiding plate is bent at an angle corresponding to the hole.

11. The multilayer automobile splashboard structure as claimed in claim 1, wherein a guiding plate is disposed at the hole of the water guiding plate, and the guiding plate is disposed facing the protruding portion.

12. The multilayer automobile splashboard structure as claimed in claim 11, wherein the guiding plate is bent at an angle corresponding to the hole.

13. The multilayer automobile splashboard structure as claimed in claim 1, wherein the outer surface of the splashboard corresponding to the tire is in an arc shape.
